(19) United States
(12) Patent Application Publication
(10) Pub. No.: US 2006/0152825 A1
(43) Pub. Date: Jul. 13, 2006

(54) Optical element to be mounted on a shaft

(76) Inventor: Gerhard Wanger, Arberg (DE)

Correspondence Address: WILLIAM COLLARD;COLLARD & ROE, P.C., 1077 NORTHERN BOULEVARD, ROSLYN, NY, 11576, US

(21) Appl. No.: 10/540,076

(22) PCT Filed: Dec. 16, 2003
(86) PCT No.: PCT/DE03/04141

§ 371 Date: Feb. 15, 2006

(30) Foreign Application Priority Data
Dec. 23, 2002 (DE) 10261530.6

(51) Int. Cl. G02B 7/02

(52) U.S. Cl. 359/819

(57) ABSTRACT

The invention relates to an optical element that is to be mounted on a shaft, particularly a spindle shaft, in order to deflect a laser beam. The laser beam is deflected via a first and a second mirror surface. At least one additional surface is provided for reducing centrifugal forces and gyroscopic moments acting upon the shaft.

The invention relates to an optical element to be mounted on a shaft, in particular on a spindle shaft, for the purpose of deflecting a laser beam, the laser beam being deflected via a first mirror face and a second mirror face.

Rapidly rotating optics (for example pentaprisms) to be mounted on a shaft which are used for the purpose of deflecting a laser beam, for example for image projection purposes, are known as the prior art. Such pentaprisms are not suitable for relatively high rotation steeds of the shaft owing to centrifugal forces and gyroscopic moments occurring.

The invention is based on the object of providing an optical element which can be used at relatively high rotation speeds as well.

This object is achieved by an optical element having the features of patent claim 1 in conjunction with the features of the preamble. Advantageous embodiments of the optical element are described in dependent claims 2-8.

The optical element has at least one further surface in addition to the first and second mirror faces known per se which are used, for example, in a pentaprism in accordance with the prior art.

Owing to the fact that at least one further surface is mounted, the physical design of the optical element is improved such that centrifugal forces and gyroscopic moments occur to a lesser extent, and thus higher rotation speeds can be achieved.

In accordance with one advantageous embodiment, the optical element has a further surface which is mounted at an angle of 25° to 65° with respect to the perpendicular of the axis of rotation of the shaft. The high-speed properties of the optical element are also improved if a further surface is mounted at an angle of 37.5° to 80° with respect to the perpendicular of the axis of rotation.

In combination, further surfaces can thus be arranged, in addition to the first and second mirror faces known from the prior art, in the optical element with an inclination within the specified angular ranges.

Owing to the mounting of further surfaces, the external geometric shape of the optical element is changed from a cylindrical element, known as the prior art, to an element having an uneven geometric shape.

Further advantageous dimensioning of the optical element will be explained in more detail in the exemplary embodiments below.

The high-speed properties of the optical element are further increased if the optical element is fixed to the shaft via an S-shaped joint. The S-shaped joint can be formed by the first mirror face and two further surfaces. More details in this context are likewise given in the exemplary embodiments illustrated below.

The invention will be explained in more detail with reference to the following exemplary embodiments in the figures of the drawing, in which:

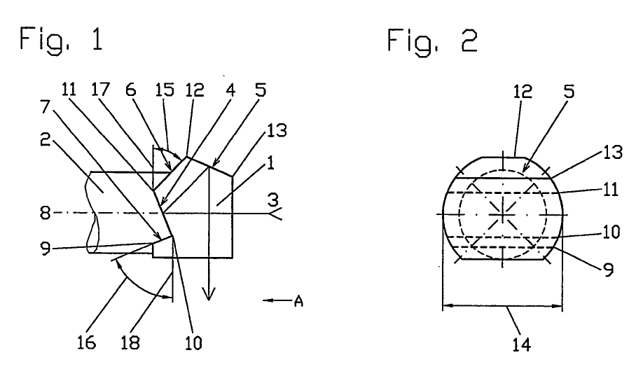

FIG. 1 shows the side view of a first embodiment of the optical element,

FIG. 2 shows a view A from FIG. 1,

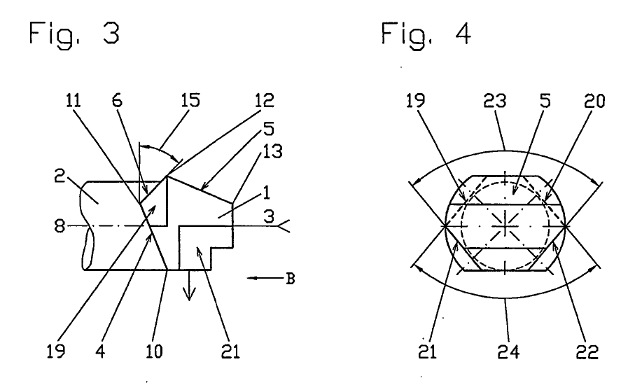

FIG. 3 shows an optical element in a second embodiment, and

FIG. 4 shows a view B from FIG. 3.

FIG. 1 shows an optical element 1, which is fixed to a shaft 2, in particular to a spindle shaft, for the purpose of deflecting a laser beam 3. The shaft 2 is in this case, in particular, a rapidly rotating shaft which achieves revolutions of up to 150 000 rpm. In the illustration shown in FIG. 1, once it has been introduced into the optical element 1 essentially parallel to the axis of rotation 8 of the shaft 2, the laser beam 3 is initially incident on the first mirror face 4 and then on a second mirror face 5 and then leaves the optical element 1. The further surface 6 can be arranged at an angle 15 with respect to the perpendicular 17 of the axis of rotation 8 of the shaft 2. In the case of the optical element 1 shown in FIG. 1, a further surface 7 is provided which is mounted at an angle 16 of 37.5° to 80° with respect to the perpendicular 18 of the axis of rotation 8.

Overall, the optical element 1 shown in FIG. 1 has additional edges 9, 10, 11, 12 and 13, the surfaces 6, 4 and 7 being arranged so as to form an S shape and forming an S-shaped joint on the optical element 1 for connection to the shaft 2.

The first mirror face 4 advantageously has edges 10 and 11, whose (identical) distance from the axis of rotation 8 of the shaft 2 is between 15% and 35% of the outer diameter 14 of the optical element 1.

In order to further improve the high-speed properties of the optical element 1, the second mirror face 5 has edges 12 and 13, the edge 13 being arranged at a distance of 45% to 110% of the diameter of the laser beam 3 from the axis of rotation 8 of the shaft 2. A diameter of the laser beam 3 can be specified at, for example, 10 mm.

FIG. 2 shows a view A from FIG. 1, in which identical elements are also provided with identical references.

FIG. 3 shows a further embodiment of an optical element 1 having a first mirror face 4, a second mirror face 5 and a further surface 6. The distances and geometrical dimensions explained in conjunction with the optical element 1 shown in FIG. 1 can also be applied to an optical element 1 shown in FIG. 3. FIG. 4 shows a view B from FIG. 3.

In order to further improve the high-speed properties, the optical element 1 can have further surfaces 19 and 20 or 21 and 22, which may be inclined at angles 24 or 23 of between 60° to 120° with respect to one another.

### REFERENCES

1 Optical element
2 Shaft
3 Laser beam
4 First mirror face
5 Second mirror face
6 Further surface
7 Further surface
8 Axis of rotation
9 Edge
10 Edge
11 Edge
12 Edge
13 Edge
14 Outer diameter
15 Angle
16 Angle
17 Perpendicular
18 Perpendicular
19 Further surface
20 Further surface
21 Further surface
22 Further surface
23 Angle
24 Angle

1. An optical element to be mounted on a shaft, in particular a spindle shaft, for the purpose of deflecting a laser beam, the laser beam being deflected via a first mirror face and a second mirror face, wherein at least one further surface (6,7) is provided for the purpose of compensating for the centrifugal forces and gyroscopic moments of the optical element (1).

2. The optical element as claimed in claim 1,
wherein the further surface (6) is mounted at an angle (15) of 25° to 65° with respect to the perpendicular (17) of the axis of rotation (8) of the shaft (2).

3. The optical element as claimed in claim 1,
wherein the further surface (7) is mounted at an angle (16) of 37.5° to 80° with respect to the perpendicular (18) of the axis of rotation (8) of the shaft (2).

4. The optical element as claimed in claim 1,
wherein the first mirror face (4) has edges (10) and (11), whose distance from the axis of rotation (8) of the shaft (2) is between 15% and 35% of the outer diameter (14) of the optical element (1).

5. The optical element as claimed in claim 1,
wherein the second mirror face (5) has edges (12) and (13), the edge (13) being arranged at a distance of 45% to 110% of the diameter of the laser beam (3) from the axis of the rotation (8) of the shaft (2).

6. The optical element as claimed in claim 1,
wherein the optical element (1) is fixed to the shaft (2) via an S-shaped joint.

7. The optical element as claimed in claim 1,
wherein at least two further surfaces (19, 20) and/or (21, 22) are provided for the purpose of compensating for the centrifugal forces and gyroscopic moments of the optical element (1).

8. The optical element as claimed in claim 7,
wherein the further surfaces (19, 20) and/or (21, 22) are arranged at angles (23 or 24) of 60° to 120° with respect to one another.
